(19) United States
(12) Patent Application Publication
(10) Pub. No.: US 2019/0366808 A1
(43) Pub. Date: Dec. 5, 2019

(54) AIR VENT FOR VEHICLE

(71) Applicant: Hyundai Mobis Co., Ltd., Seoul (KR)

(72) Inventor: Ju Yeon KANG, Yongin-si (KR)

(21) Appl. No.: 16/431,891

(22) Filed: Jun. 5, 2019

(30) Foreign Application Priority Data
Jun. 5, 2018 (KR) 10-2018-0065003

(51) Int. Cl. B60H 1/34

(52) U.S. Cl. CPC B60H 1/3421; B60H 2001/3464

(57) ABSTRACT

An air vent for a vehicle may include: a housing; a guide formed in the housing; a horizontal wing mounted on the guide such that a front end thereof is rotatable, and configured to adjust airflow up and down; and a friction part formed on a rear end of the horizontal wing, moved in a curved direction while coming in contact with the guide, and fixing the horizontal wing when an external force is removed.

### CROSS-REFERENCES TO RELATED APPLICATIONS

This application claims priority from and the benefit of Korean Patent Application No. 10-2018-0065003, filed on Jun. 5, 2018, which is hereby incorporated by reference for all purposes as if set forth herein.

### BACKGROUND

### Field

Exemplary embodiments relate to an air vent for a vehicle, and more particularly, to an air vent for a vehicle, which can adjust a manipulation force while securing an airflow rate at an outlet.

### Discussion of the Background

In general, a heating ventilating and air-conditioning system for a vehicle is installed to cool or heat the inside of the vehicle, purify indoor air of the vehicle, or maintain proper humidity, and not only maintains the inside of the vehicle in a comfortable state, but also prevents windows from being blurred or fogged, in order to secure a driver's visibility. In short, the heating ventilating and air-conditioning system helps a driver to drive safely.

In each of dash panels of a driver seat and a passenger seat, an air vent is installed to discharge air-conditioner wind or heater wind in a direction desired by a driver or passenger, such that the driver or passenger in the vehicle can drive the vehicle in a comfortable state without feeling hot or cold.

The air vent according to the related art includes horizontal wings and vertical wings which are assembled into an air vent housing. The horizontal wings adjust airflow up and down, and the vertical wings are disposed under the horizontal wing and adjust airflow from side to side.

The horizontal wings and the vertical wings are connected through hinge pieces and interlocking pieces, and one of the horizontal wings has a wing knob that enables a driver or passenger to rotate the horizontal wings and the vertical wings.

In the conventional air vent, the horizontal wings are stopped at a target position through frictional forces between the horizontal wings and the hinge pieces. However, tolerance between the parts makes it difficult to maintain the frictional force. Furthermore, when horizontal wings with a small thickness are applied, connection portions between the horizontal wings and the hinge pieces may be exposed to reduce an airflow rate. Therefore, there is a demand for a device capable of solving the problem.

The related art of the present invention is disclosed in Korean Patent Registration No. 10-1741118 registered on May 23, 2017 and entitled “Air vent apparatus”.

The above information disclosed in this Background section is only for enhancement of understanding of the background of the invention and, therefore, it may contain information that does not constitute prior art.

### SUMMARY

Exemplary embodiments of the present invention are directed to an air vent for a vehicle, which can adjust a manipulation force while securing an airflow rate at an outlet.

In one embodiment, an air vent for a vehicle may include: a housing; one or more guides formed in the housing; one or more horizontal wings mounted on the guide such that a front end thereof is rotatable, and configured to adjust airflow up and down; and a friction part formed on a rear end of the horizontal wing, moved in a curved direction while coming in contact with the guide, and fixing the horizontal wing when an external force is removed.

The guide may include: a guide body disposed in the housing; a guide mounting part formed on the guide body, such that the horizontal wing is rotatably mounted on the guide mounting part; and a guide inducement part formed on the guide body, such that the friction part is inserted into the guide inducement part and moved.

The guide inducement part may include: an inducement protrusion protruded to the inside of the guide body; and an inducement insertion part formed in the inducement protrusion, such that the friction part is inserted into the inducement insertion part.

The horizontal wing may include: a wing front end part disposed between the guide bodies and covering the inducement protrusion; a wing rear end part extended rearward from the wing front end part, having a smaller length than the wing front end part so as not to interfere with the guide inducement part, and having the friction part formed thereon; and a wing coupling part formed on the wing front end part, and rotatably pin-coupled to the guide mounting part.

The friction part may include: a friction rear protrusion protruded reward from the wing rear end part; a friction-side protrusion protruded laterally from the friction rear protrusion; and a friction contact part mounted on the friction-side protrusion, and inserted into the inducement insertion part so as to maintain contact.

The friction contact part may be made of a softer material than the inducement insertion part.

The friction contact part may have a ring shape to cover the friction-side protrusion, and be made of an elastic material or rubber.

The friction-side protrusion may include: a protrusion rod part formed through the friction contact part; and a protrusion fixing part protruded laterally from an end of the protrusion rod part, and supporting the friction contact part.

The friction-side protrusion and the friction contact part may be injection-molded as one body.

The friction contact part may have a diameter larger than the width of the inducement insertion part.

In the air vent for a vehicle in accordance with the embodiment of the present invention, since the friction part is inserted into the guide part and pressed against the guide part, the positions of the horizontal wings may be fixed by friction of the friction part when an external force is removed.

Furthermore, since the friction part is inserted into the guide part and restricted from being exposed to the outside, an airflow rate can be secured.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view schematically illustrating an air vent for a vehicle in accordance with an embodiment of the present invention.

FIG. 2 is a view illustrating the air vent for a vehicle in accordance with the embodiment of the present invention, when seen from a seated passenger.

FIG. 3 schematically illustrates a guide in accordance with the embodiment of the present invention.

FIG. 4 schematically illustrates a horizontal wing in accordance with the embodiment of the present invention.

FIG. 5 schematically illustrates a friction part in accordance with the embodiment of the present invention.

FIG. 6 schematically illustrates that the friction part in accordance with the embodiment of the present invention is guided and moved by the guide.

FIG. 7 schematically illustrates that the friction part in accordance with the embodiment of the present invention is inserted into a guide inducement part.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

Hereafter, an air vent for a vehicle in accordance with an embodiment of the present invention will be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

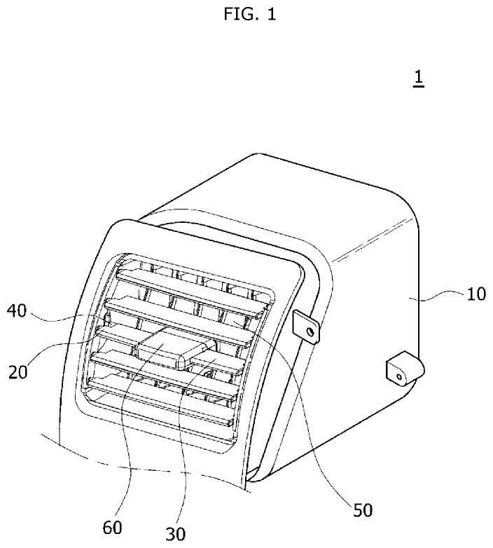

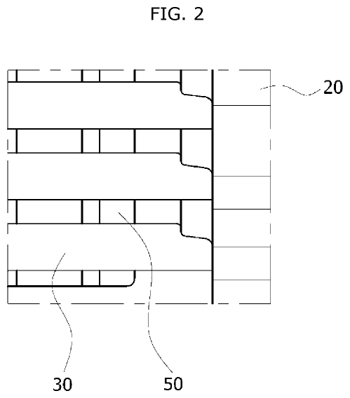

FIG. 1 is a perspective view schematically illustrating an air vent for a vehicle in accordance with an embodiment of the present invention, and FIG. 2 is a view illustrating the air vent for a vehicle in accordance with the embodiment of the present invention, when seen from a seated passenger. Referring to FIGS. 1 to 2, the air vent 1 for a vehicle in accordance with the embodiment of the present invention may include a housing 10, a guide 20, a horizontal wing 30 and a friction part 40.

The housing 10 may be mounted in the vehicle, and the guide 20 may be formed in the housing 10. For example, the guide 20 may be screwed to both insides of the housing 10. The horizontal wing 30 may be mounted on the guide 20 such that the front end thereof can be rotated, and adjust airflow up and down. For example, the horizontal wing 30 may include a plurality of horizontal wings which are arranged from top to bottom, and connected to one another so as to be rotated together. The friction part 40 may be formed at the rear end of the horizontal wing 30, and moved in a curved direction while coming in contact with the guide 20. Then, when an external force is removed, the friction part 40 may fix the horizontal wing 30.

In addition, the air vent 1 for a vehicle may include a plurality of vertical wings 50 which have a length in a top-to-bottom direction and adjust airflow from side to side. One of the horizontal wings 30 may have a knob 60 for manipulation.

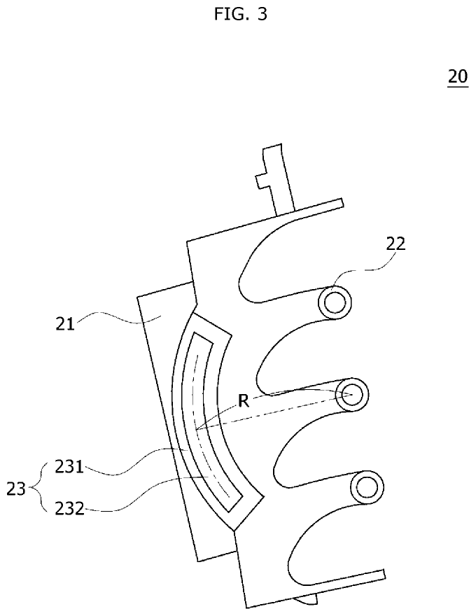

FIG. 3 schematically illustrates the guide in accordance with the embodiment of the present invention. Referring to FIG. 3, the guide 20 in accordance with the embodiment of the present invention may include a guide body 21, a guide mounting part 22 and a guide inducement part 23.

The guide body 21 may be disposed in the housing 10. For example, the guide body 21 may be positioned in both sides of the housing 10.

The guide mounting part 22 may be formed on the guide body 21, and the horizontal wing 30 may be rotatably mounted on the guide mounting part 22. For example, the guide mounting part 22 may include a plurality of guide mounting parts 22 which are protruded forward from the guide body 21 and correspond to the number of the horizontal wings 30.

The guide inducement part 23 may be formed on the guide body 21, and the friction part 40 may be inserted into the guide inducement part 23 and moved. For example, the guide inducement part 23 may be formed inside the guide body 21.

The guide inducement part 23 in accordance with the embodiment of the present invention may include an inducement protrusion 231 and an inducement insertion part 232.

The inducement protrusion 231 may be protruded to the inside of the guide body 21, and the inducement insertion part 232 may be formed in the inducement protrusion 231 such that the friction part 40 is inserted into the inducement insertion part 232. For example, the inducement insertion part 232 may have a length in the circumferential direction of a circular arc which has a radius R corresponding to a distance from the guide mounting part 22 set to the base to the inducement insertion part 232.

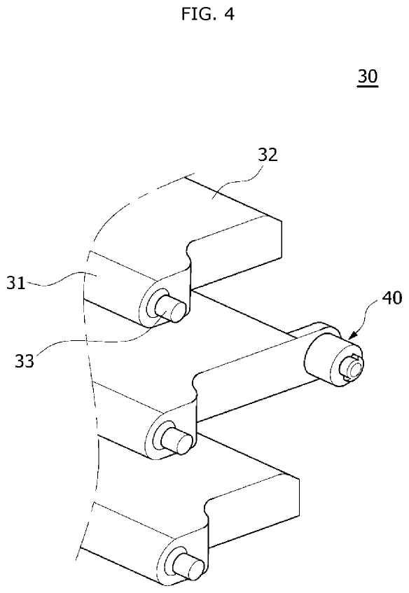

FIG. 4 schematically illustrates the horizontal wing in accordance with the embodiment of the present invention. Referring to FIG. 4, the horizontal wing 30 in accordance with the embodiment of the present invention may include a wing front end part 31, a wing rear end part 32 and a wing coupling part 33.

The wing front end part 31 may have a side-to-side length such that both ends thereof are close to the guide body 21, and cover the inducement protrusion 231 protruded to the inside of the guide body 21.

The wing rear end part 32 may be extended rearward from the wing front end part 31, have a smaller length than the wing front end part 31 so as not to interfere with the guide inducement part 23, and have the friction part 40 formed thereon. For example, both ends of the wing rear end part 32 may be disposed adjacent to the inducement protrusion 231.

The wing coupling part 33 may be protruded from both ends of the wing front end part 31, and rotatably pin-coupled to the guide mounting part 22. Thus, the horizontal wing 30 may be rotated about the wing coupling part 33 set to the axis of rotation.

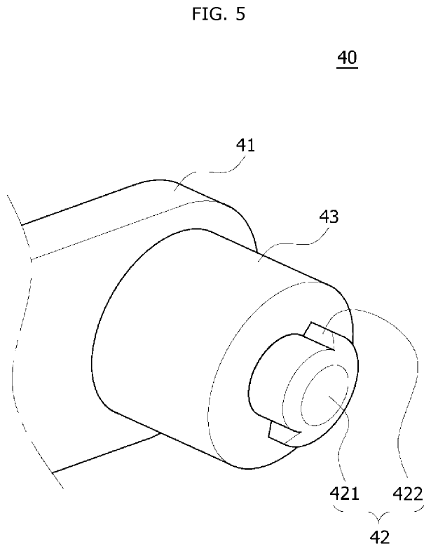

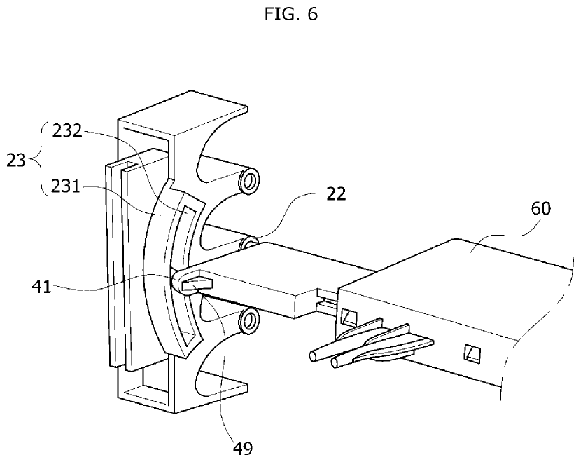

FIG. 5 schematically illustrates the friction part in accordance with the embodiment of the present invention, and FIG. 6 schematically illustrates that the friction part in accordance with the embodiment of the present invention is guided and moved by the guide. Referring to FIGS. 5 and 6, the friction part 40 in accordance with the embodiment of the present invention may include a friction rear protrusion 41, a friction-side protrusion 42 and a friction contact part 43. At this time, the friction part 40 may be installed on the horizontal wing 30 which is rotatably mounted on the guide mounting part 22 set to the base, among the plurality of horizontal wings 30, and the horizontal wing 30 having the friction part 40 installed thereon may be interlocked and rotated with the plurality of horizontal wings 30.

The friction rear protrusion 41 may be protruded rearward from the wing rear end part 32. For example, the friction rear protrusion 41 may be extended rearward from both ends of the wing rear end part 32. At this time, the friction rear protrusion 41 and the wing rear end part 32 may be connected to form a friction reinforcement part 49 for reinforcing the stiffness of the friction rear protrusion 41.

The friction-side protrusion 42 may be protruded laterally from the friction rear protrusion 41. For example, the friction-side protrusion 42 may be formed as one body with the friction rear protrusion 41.

The friction contact part 43 may be mounted on the friction-side protrusion 42, and inserted into the inducement insertion part 232 to maintain contact with the guide inducement part 23. The friction contact part 43 may be made of a softer material than the inducement insertion part 232. For example, the friction contact part 43 may be formed in a ring shape to cover the friction-side protrusion 42, and made of an elastic material or rubber.

The friction-side protrusion 42 may include a protrusion rod part 421 and a protrusion fixing part 422. The protrusion rod part 421 may be installed through the friction contact part 43, and the protrusion fixing part 422 may be protruded laterally from an end portion of the protrusion rod part 421, and prevent separation of the friction contact part 43 covering the protrusion rod part 421. At this time, the friction-side protrusion 42 and the friction contact part 43 may be injection-molded as one body. Alternatively, the friction-side protrusion 42 and the friction contact part 43 may be formed as separate parts and coupled to each other.

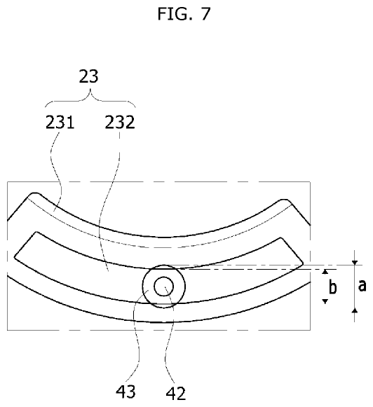

FIG. 7 schematically illustrates that the friction part in accordance with the embodiment of the present invention is inserted into the guide inducement part. Referring to FIG. 7, the diameter (a) of the friction contact part 43 may be larger than the width (b) of the inducement insertion part 232. Thus, the friction contact part 43 may be pressed against the inside of the inducement insertion part 232, and thus maintain the angle of the horizontal wing 30. At this time, a manipulation force may be adjusted according to the relationship between the diameter (a) of the friction contact part 43 and the width (b) of the inducement insertion part 232.

The operation of the air vent for a vehicle in accordance with the embodiment of the present invention will be described as follows.

The friction contact part 43 may be injection-molded as one body with the friction-side protrusion 42, the friction contact part 43 may be inserted into the inducement insertion part 232, and the wing coupling part 33 may be rotatably mounted on the guide mounting part 22.

In such a state, when a user holds the knob 60 formed on one of the horizontal wings 30 and applies an external force, the horizontal wings 30 may be rotated about the wing coupling part 33 set to the axis of rotation. At this time, the friction part 40 formed on the wing rear end part 32 may be inserted into the inducement insertion part 232 and moved. The friction contact part 43 of the friction part 40 may be pressed against the inducement insertion part 232. Thus, when the external force applied to the knob 60 is removed, the rotated horizontal wings 30 may be fixed to adjust an airflow direction.

In the air vent 1 for a vehicle in accordance with the embodiment of the present invention, since the friction part 40 is inserted into the guide 20 and pressed against the guide 20, the positions of the horizontal wings 30 may be fixed by friction of the friction part 40 when an external force is removed.

Furthermore, since the friction part 40 is inserted into the guide 20 and restricted from being exposed to the outside, an airflow rate can be secured.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. An air vent for a vehicle, comprising:
a housing;
one or more guides formed in the housing;
one or more horizontal wings mounted on the guide such that a front end of the one or more horizontal wings is configured to be rotatable, and is configured to adjust airflow up and down; and
a friction part formed on a rear end of the one or more horizontal wings, is configured to move in a curved direction while coming in contact with the guide, and is configured to fix the one or more horizontal wings when an external force is removed.

2. The air vent of claim 1, wherein the guide comprises:
a guide body disposed in the housing;
a guide mounting part formed on the guide body, such that the one or more horizontals wing are rotatably mounted on the guide mounting part; and
a guide inducement part formed on the guide body, such that the friction part is inserted into the guide inducement part and is configured to move within the guide inducement part.

3. The air vent of claim 2, wherein the guide inducement part comprises:
an inducement protrusion protruded to an inside of the guide body; and
an inducement insertion part formed in the inducement protrusion, such that the friction part is inserted into the inducement insertion part.

4. The air vent of claim 3, wherein the horizontal wing comprises:
a wing front end part disposed between the guide body and covering the inducement protrusion;
a wing rear end part extended rearward from the wing front end part, having a smaller length than the wing front end part so as not to interfere with the guide inducement part, and having the friction part formed thereon; and
a wing coupling part formed on the wing front end part, and is configured to be rotatably pin-coupled to the guide mounting part.

5. The air vent of claim 4, wherein the friction part comprises:
a friction rear protrusion protruded rearward from the wing rear end part;
a friction-side protrusion protruded laterally from the friction rear protrusion; and
a friction contact part mounted on the friction-side protrusion, and inserted into the inducement insertion part to maintain contact with the inducement insertion part.

6. The air vent of claim 5, wherein the friction contact part is made of a softer material than the inducement insertion part.

7. The air vent of claim 6, wherein the friction contact part has a ring shape to cover the friction-side protrusion, and is made of an elastic material or rubber.

8. The air vent of claim 6, wherein the friction-side protrusion comprises:
a protrusion rod part formed through the friction contact part; and
a protrusion fixing part protruded laterally from an end of the protrusion rod part, and is configured to support the friction contact part.

9. The air vent of claim 5, wherein the friction-side protrusion and the friction contact part are configured to be injection-molded as one body.

10. The air vent of claim 5, wherein the friction contact part has a diameter larger than a width of the inducement insertion part.
